(19) United States
(12) Patent Application Publication
(10) Pub. No.: US 2018/0014517 A1
(43) Pub. Date: Jan. 18, 2018

(54) FISHING LURE

(71) Applicants: George D.N. COLETTI, Stone Mountain, GA (US); Dodd H SPAIN, Stone Mountain, GA (US)

(72) Inventors: George D.N. COLETTI, Stone Mountain, GA (US); Dodd H SPAIN, Stone Mountain, GA (US)

(21) Appl. No.: 15/646,771

(22) Filed: Jul. 11, 2017

Related U.S. Application Data
(60) Provisional application No. 62/361,117, filed on Jul. 12, 2016.

(51) Int. Cl. A01K 85/16; A01K 95/00

(52) U.S. Cl. CPC A01K 85/16; A01K 95/00

(57) ABSTRACT

The present disclosure relates to a fishing lure which sinks to the bottom and upon retrieval it tends to rise to the top. The speed of rise depends upon the angle of the tongue in connection with the speed of retrieval, weight of the lure, size of the tongue, and fishing line placement to the bottom side of the tongue to the lure. The lure can be tethered by fishing line to an eyelet at a location on the bottom side of the tongue of the lure. This location may be along a range of locations on the bottom side of the tongue of the lure. This concept may be applied to any sinking lure that already exists, giving it the action of sinking down in the water and then swimming back up when line is retrieved.

### CROSS-REFERENCE TO RELATED APPLICATIONS

The present application claims all benefit and priority to U.S. Provisional Patent Application No. 62/361,117, filed 2016 Jul. 12, and fully incorporates the contents of said application and its entire file history.

### FIELD

This disclosure relates to fishing lures, and methods for making and using same.

### BACKGROUND

There are a wide variety of fishing lures, methods for making and using same. That being said, improvements are always welcomed and desired.

### SUMMARY

The present disclosure relates to a fishing lure which sinks to the bottom and upon retrieval it tends to rise to the top. The speed of rise depends upon the angle of the tongue in connection with the speed of retrieval, weight of the lure, size of the tongue, and fishing line placement to the bottom side of the tongue to the lure. The lure can be tethered by fishing line to an eyelet at a location on the bottom side of the tongue of the lure. This location may be along a range of locations on the bottom side of the tongue of the lure.

Generally described, an aspect of the present disclosure relates to a fishing lure having a leading end and configured to pass along a path through a body of water having a depth upon retrieval by a fishing line attached thereto, the fishing lure comprising: A) a base portion having a weight within a range of predetermined weights, and having a leading end and a trailing end; C) a tongue element attached to the base portion proximate the leading end of the base portion at a position within a range of predetermined tongue positions; and B) an eyelet element attached to either the leading end of the base portion or to the tongue element, the attachment being at a position within a range of predetermined eyelet positions, the eyelet configured to be attached to the fishing line to facilitate connection of the fishing line to the fishing lure, the position of the eyelet element, the position of the tongue element, and the weight of the base portion all being selected so as to provide a predetermined rise characteristic of the fishing lure through the body of water such that the fishing lure rises from a relatively lower depth to a relatively higher depth within the body of water.

A more detailed aspect of the disclosure above relates to the fishing lure as described above, wherein the range of predetermined eyelet positions includes a position at the leading end of the base portion and multiple positions on the underside of the tongue element.

A more detailed aspect of the disclosure above relates to the fishing lure as described above, wherein the tongue element is configured to be inclined at a predetermined angle in order to facilitate the rising of the lure as it is drawn through the water.

A more detailed aspect of the disclosure above relates to the fishing lure as described above, wherein the weight of the fishing lure is selected such that it sinks in water when not being retrieved by the fishing line.

A more detailed aspect of the disclosure above relates to the fishing lure as described above, wherein the tongue element is configured to be inclined at a predetermined angle in order to facilitate the rising of the lure as it is drawn through the water.

Generally described, another aspect of the present disclosure relates to a method of providing a fishing lure, having a leading end, configured to pass along a path through a body of water having a depth upon retrieval by a fishing line attached thereto, the method comprising the steps of: A) providing a base portion having a weight within a range of predetermined weights, and having a leading end and a trailing end; B) providing a tongue element attached to the base portion proximate the leading end of the base portion at a position within a range of predetermined tongue positions; and C) providing an eyelet element attached to either the leading end of the base portion or to the tongue element, the attachment being at a position within a range of predetermined eyelet positions, the eyelet configured to be attached to the fishing line to facilitate connection of the fishing line to the fishing lure, the position of the eyelet element, the position of the tongue element, and the weight of the base portion all being selected so as to provide a predetermined rise characteristic of the fishing lure through the body of water such that the fishing lure rises from a relatively lower depth to a relatively higher depth within the body of water.

A more detailed aspect of the disclosure above relates to the method as disclosed above, wherein the range of predetermined eyelet positions includes a position at the leading end of the base portion and multiple positions on the underside of the tongue element.

A more detailed aspect of the disclosure above relates to the method as disclosed above, wherein the tongue element is configured to be inclined at a predetermined angle in order to facilitate the rising of the lure as it is drawn through the water.

A more detailed aspect of the disclosure above relates to the method as disclosed above, wherein the weight of the fishing lure is selected such that it sinks in water when not being retrieved by the fishing line.

A more detailed aspect of the disclosure above relates to the method as disclosed above, wherein the tongue element is configured to be inclined at a predetermined angle in order to facilitate the rising of the lure as it is drawn through the water.

Generally described, another aspect of the present disclosure relates to a method of providing a plurality of fishing lures each having a leading end and configured to pass along a path through a body of water having a depth upon retrieval by a fishing line attached thereto, the method comprising the steps of: A) Providing a first lure, by including the following steps: 1) providing a first lure base portion having a weight within a range of predetermined weights, and having a leading end and a trailing end; 2) providing a first lure tongue element attached to the base portion proximate the leading end of the base portion at a position within a range of predetermined tongue positions; and 3) providing a first lure eyelet element attached to either the leading end of the base portion or to the tongue element, the attachment being at a position within a range of predetermined eyelet positions, the first lure eyelet element configured to be attached to the fishing line to facilitate connection of the fishing line to the first fishing lure, the position of the first lure eyelet element, the position of the first lure tongue element, and the weight of the first lure base portion all being selected in order to provide a predetermined rise characteristic of the first fishing lure through the body of water such that the first fishing lure rises from a relatively lower depth to a relatively higher depth within the body of water, B) A) providing a second lure, by including the following steps: 1) providing a second lure base portion having a weight within a range of predetermined weights, and having a leading end and a trailing end; 2) providing a second lure tongue element attached to the base portion proximate the leading end of the base portion at a position within a range of predetermined tongue positions; and 3) providing a second lure eyelet element attached to either the leading end of the base portion or to the tongue element, the attachment being at a position within a range of predetermined eyelet positions, the second lure eyelet element configured to be attached to the fishing line to facilitate connection of the fishing line to the second fishing lure, the position of the first lure eyelet element, the position of the first lure tongue element, and the weight of the first lure base portion all being selected in order to provide a predetermined rise characteristic of the second fishing lure through the body of water such that the second fishing lure rises from a relatively lower depth to a relatively higher depth within the body of water, the rise characteristic of the second fishing lure being different rate than the rise characteristic of the first fishing lure for a given retrieval rate.

A more detailed aspect of the disclosure above relates to the method as disclosed above, wherein the first lure weight is greater than the second lure weight, while the first and second lures have similarly positioned respective eyelet and tongue elements, such that the first lure rises less rapidly than the second lure for a given retrieval rate.

A more detailed aspect of the disclosure above relates to the method as disclosed above, wherein the first lure eyelet element is positioned further forward than the second lure weight, while the first and second lures have similarly positioned respective tongue elements and weights, such that the first lure rises less rapidly than the second lure for a given retrieval rate.

A more detailed aspect of the disclosure above relates to the method as disclosed above, wherein the first lure tongue element is positioned at a higher angle relative to horizontal than is the second lure tongue element, while the first and second lures have similarly positioned respective eyelet elements and weights, such that the first lure rises more rapidly than the second lure for a given retrieval rate.

A more detailed aspect of the disclosure above relates to the method as disclosed above, wherein the range of predetermined eyelet positions includes a position at the leading end of the base portion and multiple positions on the underside of the tongue element.

A more detailed aspect of the disclosure above relates to the method as disclosed above, wherein the tongue element is configured to be inclined at a predetermined angle in order to facilitate the rising of the lure as it is drawn through the water.

A more detailed aspect of the disclosure above relates to the method as disclosed above, wherein the weight of the fishing lure is selected such that it sinks in water when not being retrieved by the fishing line.

A more detailed aspect of the disclosure above relates to the method as disclosed above, wherein the tongue element is configured to be inclined at a predetermined angle in order to facilitate the rising of the lure as it is drawn through the water.

Other aspects and advantages of the present disclosure will become obvious to the reader and it is intended that these objects and advantages are within the scope of the present invention.

Generally described, another aspect of the present disclosure relates to a method of providing a fishing lure, having a leading end, configured to pass along a path through a body of water having a depth upon retrieval by a fishing line attached thereto, the method comprising the steps of: A) providing a base portion having a weight, and having a leading end and a trailing end; B) providing a tongue element attached to the base portion proximate the leading end of the base portion; and C) providing an eyelet element attached to either the leading end of the base portion or to the tongue element, the eyelet configured to be attached to the fishing line to facilitate connection of the fishing line to the fishing lure, the position of the eyelet element, the position of the tongue element, and the weight of the base portion all being selected so as to cause the fishing lure to rise through the body of water from a relatively lower depth to a relatively higher depth within the body of water.

### BRIEF DESCRIPTION OF THE DRAWINGS

FIG. 1 illustrates a perspective view of a first embodiment lure assembly 10.

FIG. 2 illustrates a right side elevational view of the lure 10. Axis Y is horizontal, and Axis X is vertical, for purposes of this text.

FIG. 3 illustrates a left side elevational view of the lure 10.

FIG. 4A illustrates a front elevational view of the lure 10.

FIG. 4B illustrates a rear elevational view of the lure 10.

FIG. 5A illustrates a top elevational view of the lure 10.

FIG. 5B illustrates a bottom elevational view of the lure 10.

FIG. 6 illustrates ranges A and B, along which the tongue may be inclined (along range A, in which tongue placement may be at any point on the top side of the lure) and along which the retrieval line may be attached relative to the body (via an eyelet attached to the body along Range B, the eyelet being attached to the front of the body, or at any point on the bottom side of the tongue).

FIG. 7 illustrates various tongue positions and eyelet positions contemplated under the present disclosure.

### DETAILED DESCRIPTION

### Introduction

The present invention now will be described more fully hereinafter with reference to the accompanying drawings, in which some, but not all embodiments of the inventions are shown. This invention may be embodied in many different forms and should not be construed as limited to the embodiments set forth herein; rather, these embodiments are provided so that this disclosure will satisfy applicable legal requirements. Like numbers refer to like elements throughout.

Reference is now made to the figures, in which like elements indicate like elements throughout the several views.

### ELEMENT LIST

Here is a list of the various elements:
5
10 Lure Assembly
12 body
14 tongue
16 hook assemblies (2)
18 eyelet

Discussion

General Constructions and Operations

Described herein is a lure assembly 10, which may have various options.

Generally described, the present disclosure relates to a fishing lure which sinks to the bottom and upon retrieval it tends to rise to the top. The speed of rise depends upon the angle of the tongue in connection with the speed of retrieval, weight of the lure, size of the tongue, and fishing line placement to the bottom side of the tongue to the lure (or front of the lure body). Selection of a particular combination of said position of said eyelet element, said position of said tongue element, and said weight of said base portion provides a predetermined rise characteristic of the fishing lure through said body of water such that said fishing lure rises from a relatively lower depth to a relatively higher depth within a body of water.

The lure can be tethered by fishing line to an eyelet at a location on the bottom side of the tongue of the lure. This location may be along a range of locations on the bottom side of the tongue of the lure (or the front of the lure body). This concept may be applied to any sinking lure that already exists, giving it the action of sinking down in the water and then swimming back up when line is retrieved.

The Lure Assembly 10 and its Elements

The lure assembly 10 includes the following elements:
body 12
tongue 14
hook assemblies 16 (2)
eyelet 18

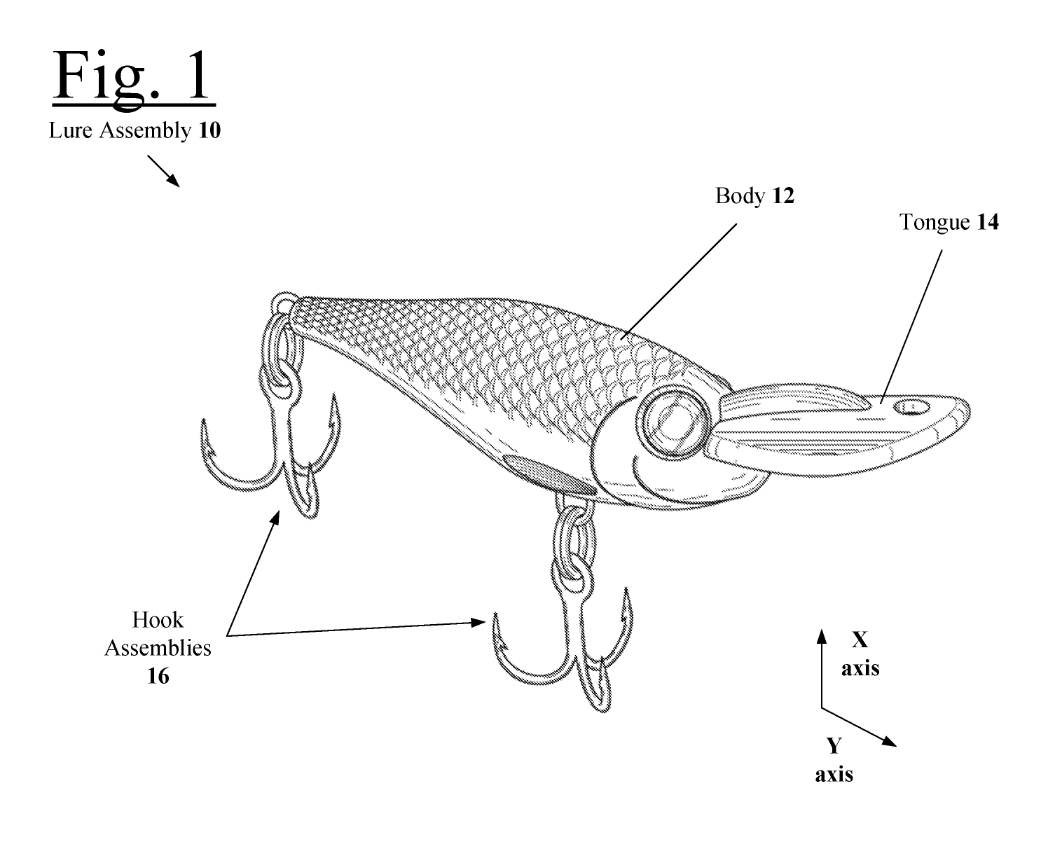

Referenced is now made to FIG. 1, which illustrates a perspective view of a first embodiment lure assembly 10. Shown are a body 12, a tongue 14 extending from the front of the body, two sets of hook assemblies 16 extending generally downward from the body, and an eyelet 18 attached to the nose of the lure body, configured to facilitate the attachment of fishing line to the lure to facilitate casting and retrieval. Also generally referenced are the other figures.

The body 12 generally simulates the shape of a minnow, although other configurations may be used.

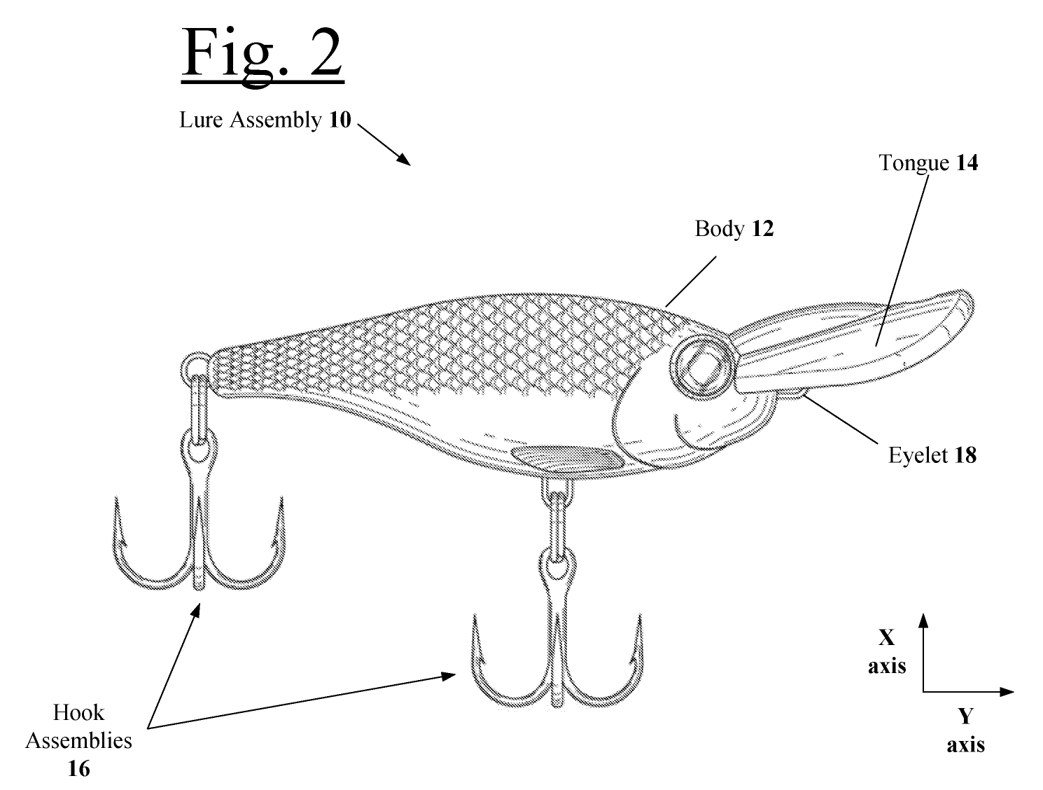

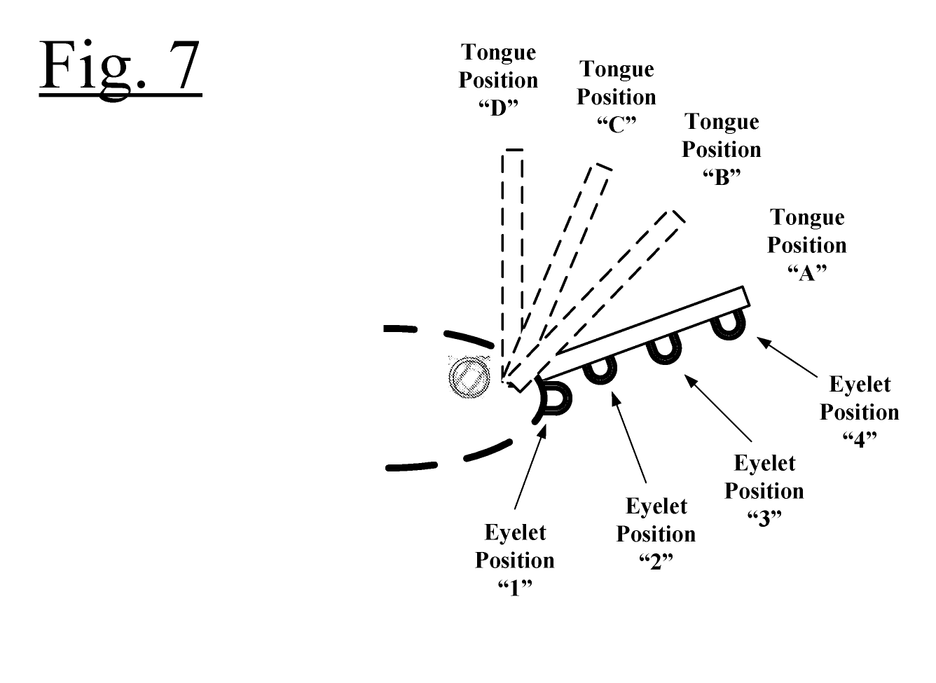

The tongue 14 extending from the front of the body 12, and in the configuration also extends slightly “up” at a slight angle relative to horizontal, assuming the lure is considered to be oriented as shown in FIG. 2 with the Y axis being horizontal. This tongue 14 is also shown as being in tongue position “A” in FIG. 7. The tongue in and of itself is similar to other tongues in the art in that it provides a function of slicing into the oncoming water and causing the lure to go higher or lower depending on its angular position relative to the water flow thereby.

The two sets of hook assemblies 16 extend generally downward from the body 12, with one set being generally near the front, and the other set being generally near the back. More or less hook assemblies could be used.

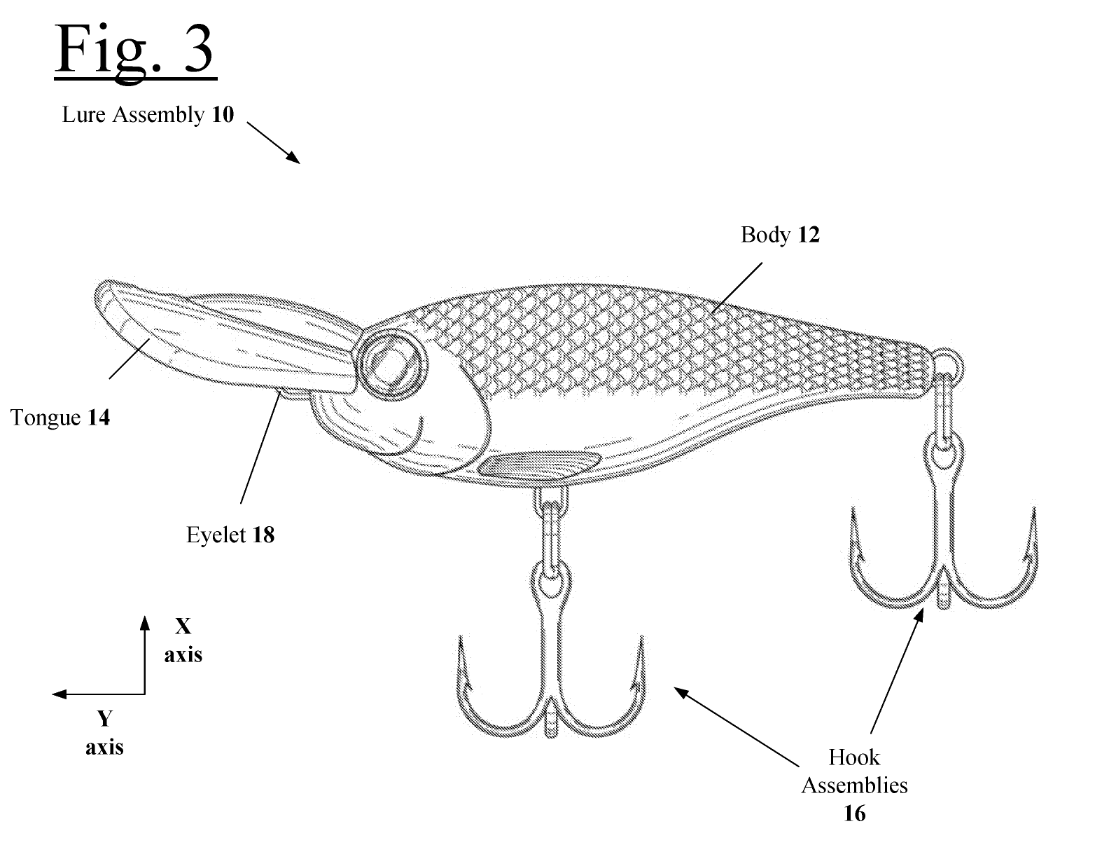

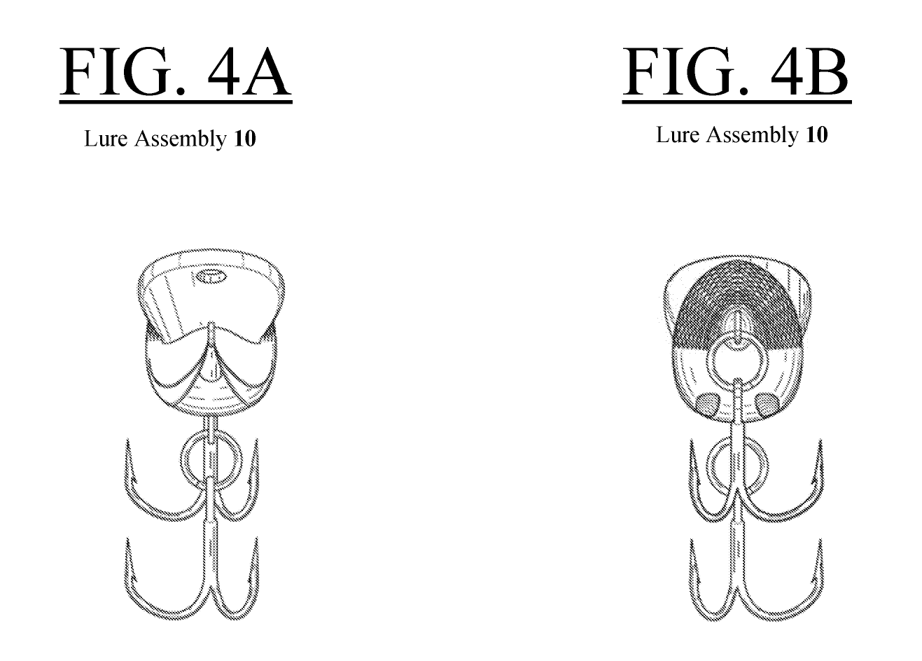

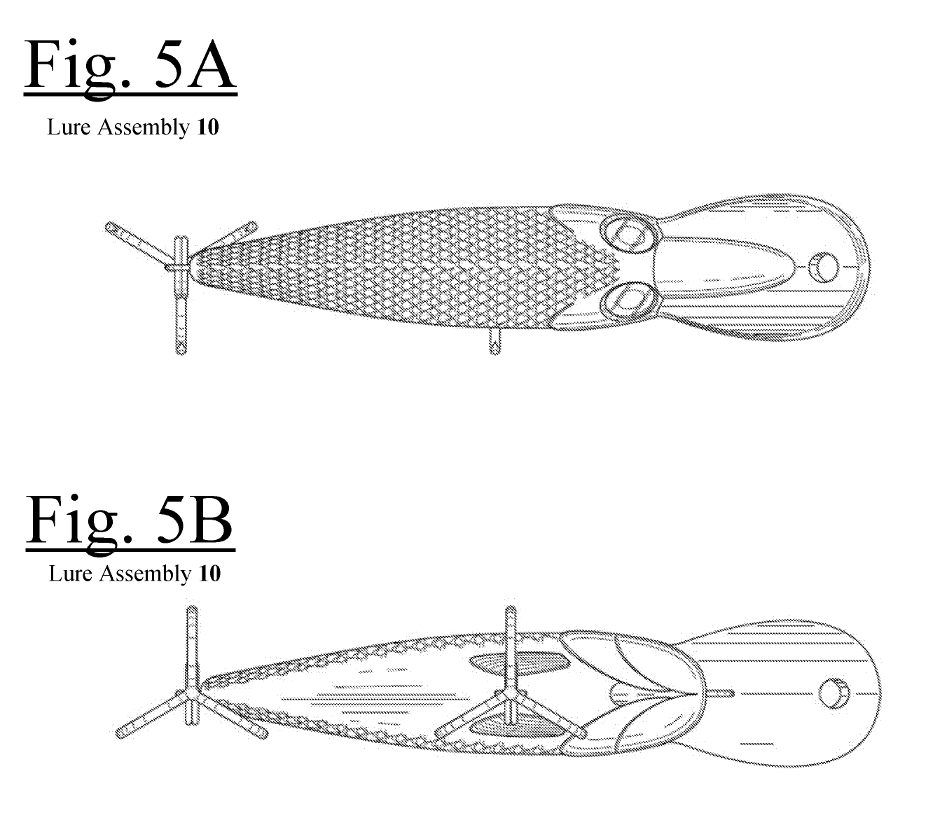

The eyelet 18 shown in the embodiment in FIGS. 1-5B is located at the front nose of the body 12 of the lure assembly 10. This eyelet 18 is also shown as being in eyelet position “1” in FIG. 7.

The other eyelet positions and other tongue positions will be described below in describing other configurations and other options.

Other Configurations and Other Options

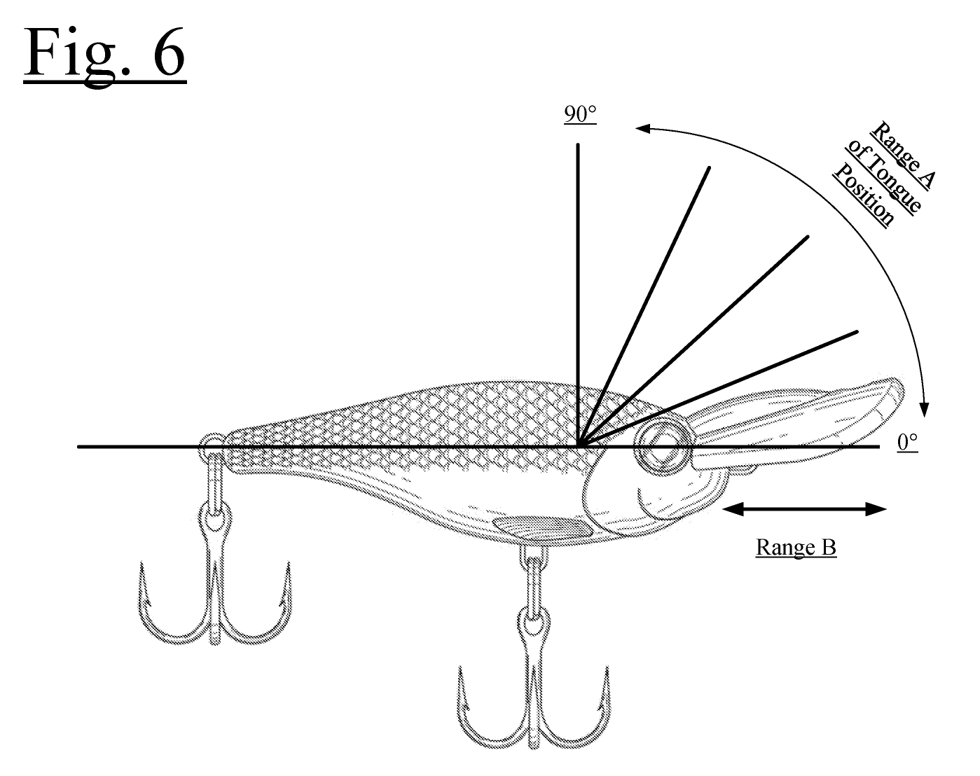

Reference is now made generally to FIGS. 6 and 7 in order to discuss variations on the embodiment 10 described above.

FIG. 6 illustrates ranges along which the tongue may be inclined (along range A) and along which the retrieval line may be attached relative to the body (via an eyelet attached to the body along Range B).

FIG. 7 illustrates various tongue positions and eyelet positions contemplated under the present disclosure. Tongue position “A” is the position of the tongue in the embodiment 10 for reference. Tongue position “B” is a more inclined position (relative to the horizontal axis) than is tongue position “A”. Tongue position “C” is a more inclined position (relative to the horizontal axis) than is tongue position “B”. Tongue position “D” is a more inclined position (in this case approaching vertical) than is tongue position C”. The phrase “more inclined position” should be understood as synonymous with having a “higher angle relative to horizontal”.

FIG. 7 also illustrates various eyelet positions contemplated under the present disclosure, in Range B of FIG. 6. Eyelet position “1” is the position of the tongue in the embodiment 10 for reference; in this position the eyelet is attached to the body of the lure. Eyelet position “2” is a position in which the eyelet is attached to the tongue proximate the end of the tongue attached to the body of the lure. Eyelet position “3” is a position in which the eyelet is attached further forward on the tongue compared to eyelet position “2”. Eyelet position “4” is a position in which the eyelet is attached further forward on the tongue compared to eyelet position “4”, and is proximate the end of the tongue not attached to the body of the lure.

It should be understood that any of the tongue positions may be used with any of the eyelet positions.

The lure operates differently for different tongue positions (for a given eyelet position). The more inclined the tongue position, the more rapidly the lure rises for a given retrieval, all else being the same.

The lure operates differently for different eyelet positions (for a given tongue position). The further forward the eyelet position, the less rapidly the lure rises for a given retrieval, all else being the same.

The lure operates differently for different weights (for a given tongue and eyelet position). The heavier the lure, the less rapidly the lure rises for a given retrieval, all else being the same.

### CONCLUSION

Various modifications and variations can be made in the present invention without departing from the spirit or scope of the invention.

Although the description herein has been made with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A fishing lure having a leading end and configured to pass along a path through a body of water having a depth upon retrieval by a fishing line attached thereto, said fishing lure comprising:
A) a base portion having a weight within a range of predetermined weights, and having a leading end and a trailing end;
C) a tongue element attached to said base portion proximate said leading end of said base portion at a position within a range of predetermined tongue positions; and
B) an eyelet element attached to either said leading end of said base portion or to said tongue element, said attachment being at a position within a range of predetermined eyelet positions, said eyelet configured to be attached to said fishing line to facilitate connection of said fishing line to said fishing lure,
said position of said eyelet element, said position of said tongue element, and said weight of said base portion all being selected so as to provide a predetermined rise characteristic of said fishing lure through said body of water such that said fishing lure rises from a relatively lower depth to a relatively higher depth within said body of water.

2. The fishing lure as claimed in claim 1, wherein said range of predetermined eyelet positions includes a position at the leading end of said base portion and multiple positions on the underside of said tongue element.

3. The fishing lure as claimed in claim 1, wherein said tongue element is configured to be inclined at a predetermined angle in order to facilitate the rising of said lure as it is drawn through the water.

4. The fishing lure as claimed in claim 1, wherein said weight of said fishing lure is selected such that it sinks in water when not being retrieved by said fishing line.

5. The fishing lure as claimed in claim 4, wherein said tongue element is configured to be inclined at a predetermined angle in order to facilitate the rising of said lure as it is drawn through the water.

6. A method of providing a fishing lure, having a leading end, configured to pass along a path through a body of water having a depth upon retrieval by a fishing line attached thereto, said method comprising the steps of:
A) providing a base portion having a weight within a range of predetermined weights, and having a leading end and a trailing end;
B) providing a tongue element attached to said base portion proximate said leading end of said base portion at a position within a range of predetermined tongue positions; and
C) providing an eyelet element attached to either said leading end of said base portion or to said tongue element, said attachment being at a position within a range of predetermined eyelet positions, said eyelet configured to be attached to said fishing line to facilitate connection of said fishing line to said fishing lure,
said position of said eyelet element, said position of said tongue element, and said weight of said base portion all being selected so as to provide a predetermined rise characteristic of said fishing lure through said body of water such that said fishing lure rises from a relatively lower depth to a relatively higher depth within said body of water.

7. The method as claimed in claim 6, wherein said range of predetermined eyelet positions includes a position at the leading end of said base portion and multiple positions on the underside of said tongue element.

8. The method as claimed in claim 6, wherein said tongue element is configured to be inclined at a predetermined angle in order to facilitate the rising of said lure as it is drawn through the water.

9. The method as claimed in claim 6, wherein said weight of said fishing lure is selected such that it sinks in water when not being retrieved by said fishing line.

10. The method as claimed in claim 9, wherein said tongue element is configured to be inclined at a predetermined angle in order to facilitate the rising of said lure as it is drawn through the water.

11. A method of providing a plurality of fishing lures each having a leading end and configured to pass along a path through a body of water having a depth upon retrieval by a fishing line attached thereto, said method comprising the steps of:
A) Providing a first lure, by including the following steps:
1) providing a first lure base portion having a weight within a range of predetermined weights, and having a leading end and a trailing end;
2) providing a first lure tongue element attached to said base portion proximate said leading end of said base portion at a position within a range of predetermined tongue positions; and
3) providing a first lure eyelet element attached to either said leading end of said base portion or to said tongue element, said attachment being at a position within a range of predetermined eyelet positions, said first lure eyelet element configured to be attached to said fishing line to facilitate connection of said fishing line to said first fishing lure,
said position of said first lure eyelet element, said position of said first lure tongue element, and said weight of said first lure base portion all being selected in order to provide a predetermined rise characteristic of said first fishing lure through said body of water such that said first fishing lure rises from a relatively lower depth to a relatively higher depth within said body of water,
B) A) providing a second lure, by including the following steps:
1) providing a second lure base portion having a weight within a range of predetermined weights, and having a leading end and a trailing end;
2) providing a second lure tongue element attached to said base portion proximate said leading end of said base portion at a position within a range of predetermined tongue positions; and
3) providing a second lure eyelet element attached to either said leading end of said base portion or to said tongue element, said attachment being at a position within a range of predetermined eyelet positions, said second lure eyelet element configured to be attached to said fishing line to facilitate connection of said fishing line to said second fishing lure,
said position of said second lure eyelet element, said position of said second lure tongue element, and said weight of said second lure base portion all being selected in order to provide a predetermined rise characteristic of said second fishing lure through said body of water such that said second fishing lure rises from a relatively lower depth to a relatively higher depth within said body of water, said rise characteristic of said second fishing lure being different than said rise characteristic of said first fishing lure for a given retrieval rate.

12. The method as claimed in claim 10, wherein said first lure weight is greater than said second lure weight, while said first and second lures have similarly positioned respective eyelet and tongue elements, such that said first lure rises less rapidly than said second lure for a given retrieval rate.

13. The method as claimed in claim 10, wherein said first lure eyelet element is positioned further forward than said second lure weight, while said first and second lures have similarly positioned respective tongue elements and weights, such that said first lure rises less rapidly than said second lure for a given retrieval rate.

14. The method as claimed in claim 10, wherein said first lure tongue element is positioned at a higher angle relative to horizontal than is said second lure tongue element, while said first and second lures have similarly positioned respective eyelet elements and weights, such that said first lure rises more rapidly than said second lure for a given retrieval rate.

15. The method as claimed in claim 11, wherein said range of predetermined eyelet positions includes a position at the leading end of said base portion and multiple positions on the underside of said tongue element.

16. The method as claimed in claim 11, wherein said tongue element is configured to be inclined at a predetermined angle in order to facilitate the rising of said lure as it is drawn through the water.

17. The method as claimed in claim 11, wherein said weight of said fishing lure is selected such that it sinks in water when not being retrieved by said fishing line.

18. The method as claimed in claim 17, wherein said tongue element is configured to be inclined at a predetermined angle in order to facilitate the rising of said lure as it is drawn through the water.

19. A method of providing a fishing lure, having a leading end, configured to pass along a path through a body of water having a depth upon retrieval by a fishing line attached thereto, said method comprising the steps of:
A) providing a base portion having a weight, and having a leading end and a trailing end;
B) providing a tongue element attached to said base portion proximate said leading end of said base portion; and
C) providing an eyelet element attached to either said leading end of said base portion or to said tongue element, said eyelet configured to be attached to said fishing line to facilitate connection of said fishing line to said fishing lure,
said position of said eyelet element, said position of said tongue element, and said weight of said base portion all being selected so as to cause said fishing lure to rise through said body of water from a relatively lower depth to a relatively higher depth within said body of water.
